(19) United States
(12) Patent Application Publication
(10) Pub. No.: US 2023/0105101 A1
(43) Pub. Date: Apr. 6, 2023

(54) DOOR KNOB STOPPER

(71) Applicant: Magam Investment Associates, LP, Murrysville, PA (US)

(72) Inventor: Michael A. Garofalo, Murrysville, PA (US)

(73) Assignee: Magam Investment Associates, LP, Murrysville, PA (US)

(21) Appl. No.: 17/959,666

(22) Filed: Oct. 4, 2022

Related U.S. Application Data
(60) Provisional application No. 63/252,312, filed on Oct. 5, 2021.

(51) Int. Cl. E05F 5/06

(52) U.S. Cl. CPC E05F 5/06

(57) ABSTRACT

This invention relates to a door knob stopper that is recessed into and secured to the wall behind a door and prevents the door knob from damaging the wall if the door knob hits the wall.

### CROSS-REFERENCE TO RELATED APPLICATION

This application claims priority to U.S. Provisional App. Serial No. 63/252,312, filed on Oct. 5, 2021, which application is incorporated by reference herein in its entirety.

### BACKGROUND OF THE INVENTION

### Field of the Invention

This invention relates to a door knob stopper or receptacle that is recessed into the wall behind a door and prevents the door knob from damaging the wall if the door knob hits the wall.

### Description of Related Art

The present invention is a door knob stopper or a door knob receiver (collectively referred to herein as a “door knob stopper”). More specifically, the door knob stopper of the present invention is a cup-like device that is recessed into a wall to receive a door knob that would otherwise strike the wall if the door was opened all the way, too quickly or with great force. In general, doors are hung within a door frame such that if the door is opened quickly and with excessive force, the door knob will impact the wall behind it and damage the wall. Frequently, this results in damage that ranges from cracked or chipped paint to a large hole being punched in the wall.

Repairing a damaged wall is a difficult, tedious process. Often it involves cutting around the damaged section to create clean edges and then patching the drywall or plaster. Frequently, the patch needs to be sanded and plastered multiple times to achieve a surface that blends seamlessly with the surrounding wall. Finally, the finished patched will need to be painted with at least one coat of paint to match the surrounding wall. Once fixed, the repaired wall is still susceptible to the same damage whenever the door is opened with excessive speed or force unless a device is used to stop the door or door knob or to receive the door knob.

A number of technologies exist to attempt to solve this problem. Traditional baseboard door stoppers and hinge door stoppers are the most common solution; however, they fail quite often. Whether it is a vacuum cleaner running into baseboard door stoppers or the power of herculean children blasting through hinge door stoppers, more often than not these two common door stops break, fall apart, or simply do not work. Other solutions are bulbous hard plastic or rubber bumpers. Examples of such technologies are disclosed in U.S. Pat. Nos. 3,386,125, 3,824,649 and 324,170. Devices such as these are secured to the wall behind the door. These devices fail to provide adequate protection against damage to the wall if the door is opened with excessive force such that when the door knob contacts the bumper the impact will still fracture the wall area surrounding the bumper. Additionally, depending upon the material from which these bumpers are made, the door knob can hit the bumper and bounce back to impact the person who opened the door. Another problem with these bumpers is that their size prevents a door from opening as wide as it normally would. Finally, these bumpers tend to be unsightly and negatively impact the aesthetics of the wall and/or room.

The general idea of a wall insert or receptacle for a door knob is known and an example of one can be seen in U.S. Pat. No. 5,611,110 to Smith. However, the existing recessed door knob receptacles are limited in scope because they require the use of a separate securing mechanism such as glue, double-sided tape, Velcro®, screws, nails, etc. The present invention simplifies the installation process with a design that self-secures to a hole in the wall without the use of a separate securing mechanism.

The need for a simple-to-install door knob stopper is particularly great in both rental properties and mobile homes; however, its use extends to all environments, including all homes and offices, etc. In rental properties for example, numerous tenants rotate through properties that they are not always inclined to take care of. The adults, children and pets open or bump into the doors often with sufficient force to impact and damage the wall behind the doors. Frequently in the situation of rental properties, property owners and handymen do not have the time or skill to install traditional door knob stoppers, particularly those styles that require cutting a hole of a specific size in the wall and then installing the stopper, nor do they have the time or skill necessary for the multi-step patch and paint jobs that are required to repair a damaged wall. In rental situations, there is a need for a very quick and simple to install product that can fix a wall that has been damaged by a door knob and prevent future damage of the same type. The current invention addresses this need among the many other needs outlined herein.

### BRIEF SUMMARY OF THE INVENTION

One embodiment of the present invention is a door knob stopper configured to receive a door knob into a hole in a wall. The door knob stopper of this embodiment comprises a receptacle sized to receive a door knob and having a circumferential sidewall, which has an interior and an exterior. The circumferential sidewall connects a rear wall to a face plate, which has a front side and a back side. The door knob stopper of this embodiment also has a securing mechanism to secure the door knob stopper to the hole in the wall.

Another embodiment of the present invention is a method of installing a door knob stopper into a wall having a hole, the door knob stopper having a receptacle with a rear wall configured to receive a door knob and a securing mechanism. The method of this embodiment comprises aligning the rear wall of the receptacle with the hole in the wall and then pushing and, for some embodiments, turning the door knob stopper until the securing mechanism cuts into and grabs the wall around the hole..

### BRIEF DESCRIPTION OF THE SEVERAL VIEWS OF THE DRAWINGS

For the purpose of facilitating understanding of the invention, the accompanying drawings and description illustrate preferred embodiments thereof, from which the invention, various embodiments of its structures, construction and method of operation, and many advantages, may be understood and appreciated. The accompanying drawings are hereby incorporated by reference.

FIG. 1 illustrates one embodiment of a door knob stopper of the present invention with fins;

FIGS. 2A through 2D illustrate various views of an embodiment of a door knob stopper of the present invention that can be modified to use any of the securing mechanisms disclosed herein;

FIGS. 3A through 3D illustrate various views of an embodiment of a door knob stopper of the present invention having teeth;

FIGS. 4A and 4B illustrate a method of installing a door knob stopper of the present invention; and

FIGS. 5A through 5D show a variety of views of one alternative embodiment of a door knob stopper according to the present invention with fins and a spacer.

### DETAILED DESCRIPTION OF THE INVENTION

The following describes example embodiments in which the present invention may be practiced. This invention, however, may be embodied in many different ways, and the descriptions provided herein should not be construed as limiting in any way. Among other things, the following invention may be embodied as methods, systems or devices. The following detailed descriptions should not be taken in a limiting sense. The accompanying drawings are hereby incorporated by reference.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

While the disclosure has been described in detail and with reference to specific embodiments thereof, it will be apparent to one skilled in the art that various changes and modifications can be made therein without departing from the spirit and scope of the embodiments. Thus, it is intended that the present disclosure covers the modifications and variations of this disclosure provided they come within the scope of the appended claims and their equivalents.

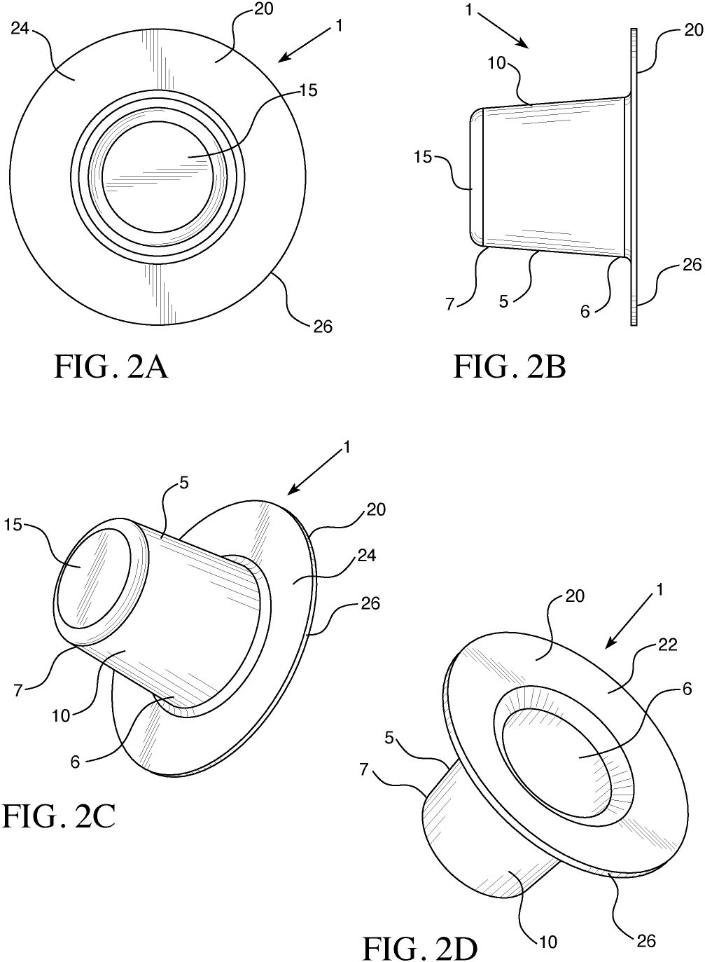

The various embodiments of the present invention door knob stopper 1 share a basic design (shown in FIGS. 2A through 2D), from which different embodiments vary depending upon the securing mechanism 30 that is used (among other things). The various securing mechanisms 30 provide for an installation that, in many circumstances, does not require tools to install the door knob stopper 1 nor to get the door knob stopper 1 to adhere to the wall.

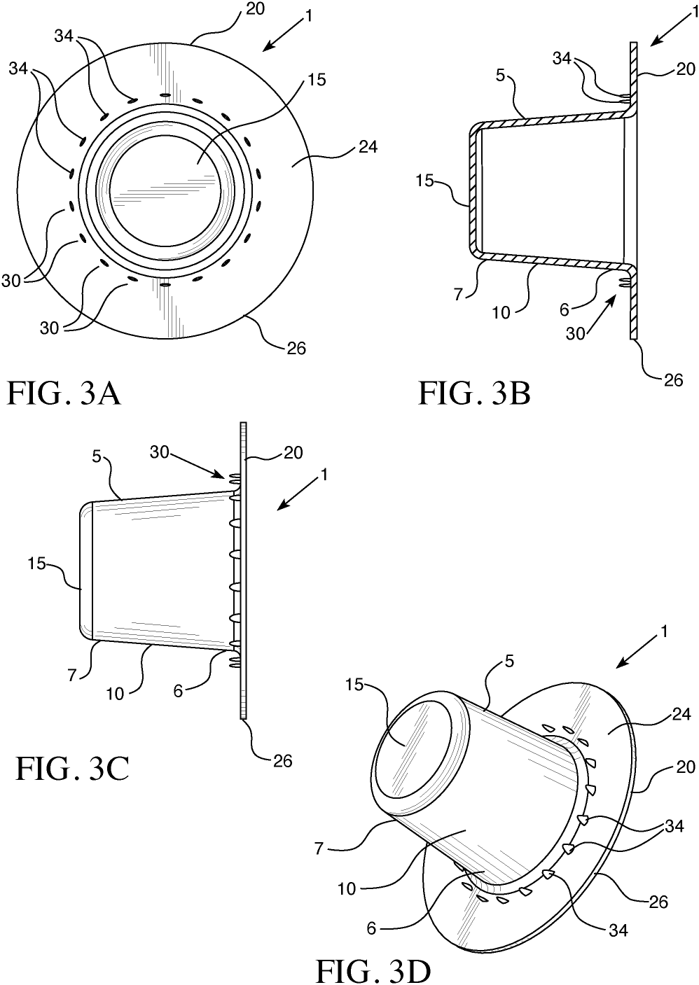

The basic design of most embodiments of a door knob stopper 1 of the present invention is shown in FIGS. 2A through 2D. This design comprises a receptacle 5 that is of a size and shape to receive a door knob (see FIGS. 2B and 2C). The size and shape can vary to depending upon the type of door knob with which the stopper 1 will be used and also the wall material, depth and installation location. The receptacle 5 is comprised of a circumferential sidewall 10, having an interior and an exterior. The circumferential sidewall 10 creates the walls of the receptacle 5 between the back 7 of the receptacle 5, also referred to as the rear wall 15 of the receptacle 5, and the front 6 of the receptacle 5, which sits closer to the face of the wall 200 into which the stopper 1 is installed. The circumferential sidewall 10 defines the depth of the door knob stopper 1 that is appropriate for the door knob and for the wall 200 into which the stopper 1 will be recessed. One end (the front 6) of the door knob stopper 1 is open to receive the door knob. The opposing end (the back 7) is a closed rear wall 15. In most embodiments of the present invention, the rear wall 15 of the stopper 1 and the circumferential side wall 10 sit fully within the wall 200 into which the stopper 1 is recessed. In a preferred embodiment of the present invention, the circumferential sidewall 10 is tapered from the wider front 6 of the receptacle 5 to the smaller rear wall 15 (see FIGS. 2B, 2D, and 3B through 3D). This tapering from the front 6 to the rear 7 of the receptacle 5 aids in the tool-less installation of the door knob stopper 1. However, variations of the present invention encompass designs where the front 6 of the receptacle 5 and the rear wall 15 are the same size or close to the same size as well.

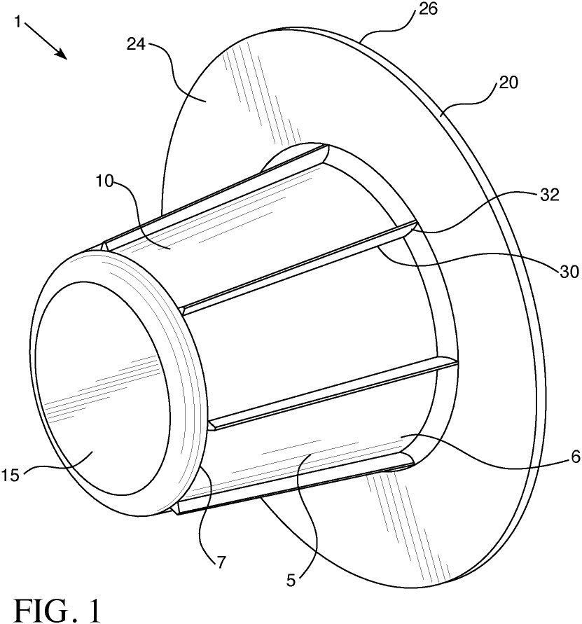

The front 6 of the receptacle 5 is attached to or becomes (depending on the manufacturing method and design employed) a face plate 20 that generally sits on the face 220 of the wall 200. For the embodiments shown in FIGS. 1 through 5, the face plate 20 sits essentially flush or almost flush with the surrounding wall 200, with an allowance being made for the depth of the face plate 20 and the smoothness or evenness of the surrounding wall 200. The face plate 20 has a front side 22 that is visible within the room in which the stopper 1 is located and on the surrounding wall 200. The face plate 20 also has a back side 24 that is adjacent to the surrounding wall 200 and is not visible once the door knob stopper 1 is installed.

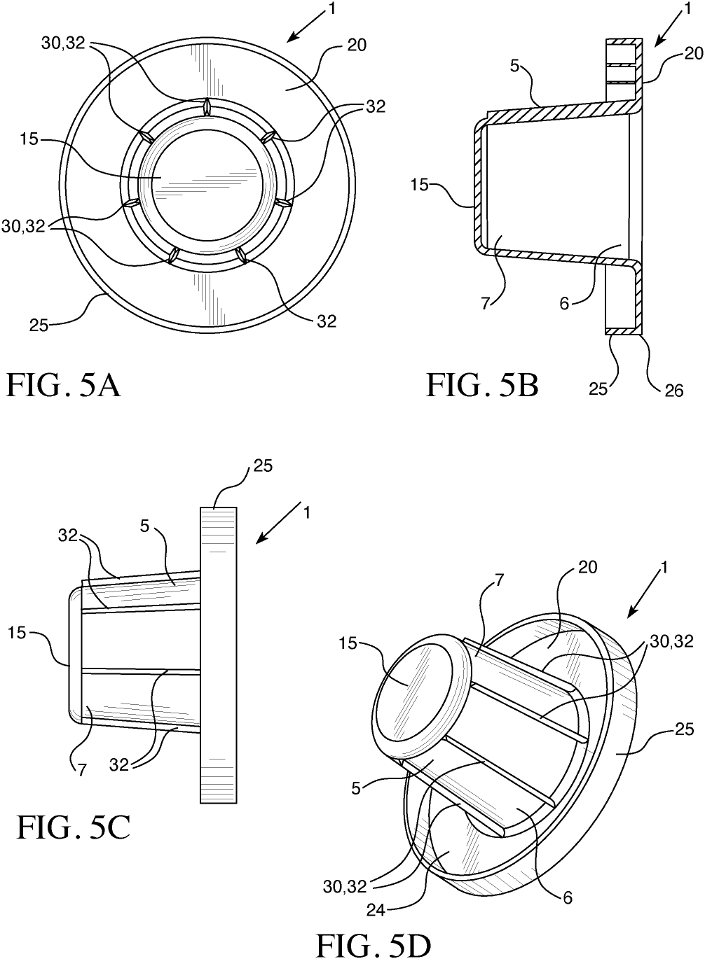

In an alternative embodiment shown in FIGS. 5A through 5D, the door knob stopper 1 also comprises a spacer 25. The spacer 25 is an edge or additional piece of material of any dimensions that sits between the back side 24 of the face plate 20 and the face 220 of the wall 200 to create space between the face plate 20 and the surrounding wall 200. One embodiment of a spacer 25 is shown in FIGS. 5A through 5D. For this embodiment, the spacer 25 runs along the outermost edge 26 of the face plate 20. However, different embodiments of spacers 25 of the present invention can be located along or behind any portion of the face plate 20 to create any desired amount of space between the back side 24 of the face plate 20 and the face 220 of the wall 200.

This optional spacer 25 design is desirable and usable in a variety of situations. In certain structures, such as mobile homes, the interior depth of a wall 200 may not be sufficient to receive a standard door knob or a door knob stopper 1. The spacer 25 creates or enables the use of a receptacle 5 that is deeper than what could normally be installed in a shallow wall 200. Alternatively, the use of a spacer 25 can create some additional space between the wall 200, the installed door knob stopper 1 and the door in environments that lack a baseboard, quarter round, chair rail, or other trim to separate the door from the wall. In contrast, the alternative design, without the use of the spacer 25, allows the open door to sit closer to the wall 200 and creates a minimal profile wherein the stopper 1 sits almost flush to the wall 200 and with the receptacle 5 fully within the wall 200.

Most embodiments of a door knob stopper 1 of the present invention utilize a securing mechanism 30 to secure the door knob stopper 1 to the wall 200 without necessitating the use of glue, Velcro®, tape, screws or nails. Two basic embodiments of a door knob stopper 1 according to the present invention are shown in FIGS. 1, 3A through 3D and 5A through 5D. A preferred design of the securing mechanism 30 for various embodiments of the present invention is fins 32. Various embodiments having fins 32 are shown in FIGS. 1, 5C and 5D. The fins 32 run along at least a portion of the length of the exterior of the circumferential side wall 10. The fins 32 can be designed to have the same dimensions across the length of each fin 32. Alternatively, as shown in FIG. 1, the fins 32 can be designed to taper from the front 6 of the receptacle 5 to the back 7 of the receptacle 5.

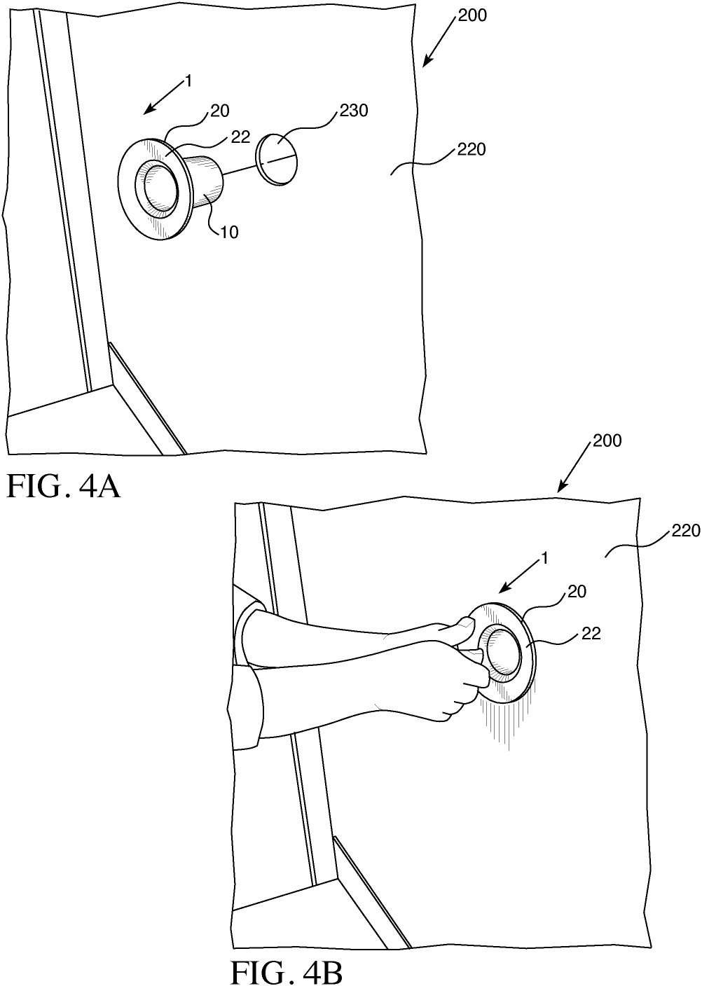

During installation of these embodiments of the door knob stopper 1, the fins 32 serve a dual purpose of cutting into the wall 200 and creating a tight, securing fit between the door knob stopper 1 and the surrounding wall 200 that resists the door knob stopper 1 simply falling out of the wall 200. The tapered design of one embodiment of fins 32 enable the fins 32 to cut through the wall 200 and allow for the repair and/or installation of the door knob stopper 1 to be done without the use of tools. As explained previously, in order to repair a damaged wall 200 and/or install a device similar to the present invention, a hole 230 needs to be cut into the wall 200 using some cutting tool such as a hole saw or a drywall knife, both of which can be difficult, cumbersome and require some degree of user skill. The fins 32 gently remove the excess drywall or wall material in the preexisting hole 230 (often caused by a doorknob crashing into the wall) to accommodate the door knob stopper 1. The hole 230 reaming done by the fins 32 is accomplished by several twists of the stopper 1 during installation and then the tapered design of stopper 1 allows for it to be pushed into place and to self-secure in the wall 200 (see FIGS. 4A and 4B). The fins 32 can be of any length, depth or number that works with the dimensions of the intended wall 200, the wall material and/or the door knob to be received. In general, at least three fins 32 can be used to securely attach the door knob stopper 1 to the wall 200. Additional fins 32 can be used also.

A second embodiment of the door knob stopper 1 utilizes teeth 34, alone or in addition to fins 32, to secure the stopper 1 to the wall 200. This embodiment is illustrated in FIGS. 3A through 3D. For this embodiment, the teeth 34 help to grab or dig into the surrounding wall 200 to better secure the door knob stopper 1 to and in the wall 200. Other similar mechanisms can be used to firmly secure stopper 1 in the wall 200.

The individual elements of the door knob stopper 1 may all be designed to be one piece, for example by manufacturing the door knob stopper 1 using 3-D printing or injection molding. Alternatively, the one or more of the individual elements of the door knob 1 may be manufactured separately and then assembled into the final product.

Similarly, the individual elements of the various embodiments of a door knob stopper 1 of the present invention can be made of the same material or they may be made of different materials. The entire door knob 1 can be made of any of a wide variety of plastics and plastic-type materials. The possible plastic materials may be flexible or inflexible. Alternatively, there may be embodiments that use metal teeth 34 and/or metal fins 32. Alternative embodiments also may be designed to have the face plate 20 and/or spacer 25 made out of a different material from the rest of the door knob stopper 1 for aesthetic or functional purposes, such as to match the other decorative elements in a room.

The present invention also encompasses a tool-less method of installing a door knob stopper 1. This method anticipates that there will be some sort of preexisting hole 230 in the wall 200 that corresponds to the desired location of the door knob stopper 1. That hole 230 can be cut into the wall 200 by the user. However, that hole 230 may have been created by a door knob impacting that wall 200 and damaging the wall 200 behind the door. In any situation, the hole 230 does not have to precisely match the dimensions of the door knob stopper 1. The hole 230 merely needs to be sufficiently sized to mostly accommodate the rear wall 15 of the stopper 1 such that, with some force or pressure, the receptacle 5 can be pushed into and through this initial hole 230 (as shown in FIGS. 4A and 4B).

The installation method of the present invention entails aligning the rear wall 15 of the door knob stopper 1 with the hole 230 or damage in the surrounding wall 230 (see FIG. 4A) and then pushing and, for certain securing mechanisms 30 such as fins 32, turning the door knob stopper 1 until the securing mechanism 30 engages the wall 200 and secures the stopper 1 (see FIG. 4B). At that point and if the stopper 1 is not fully installed, the stopper 1 is pushed straight into the wall 200 until either the back side 24 of the face plate 20 or the spacer 25 is flush with or in contact with the wall 200. For some embodiments of a method of installing a door knob stopper 1 of the present invention, the door knob stopper 1 can be pushed into the wall 200 without turning the stopper 1 during installation. The turning of the stopper 1 aid in situations where fins 32 or a similar structure are included to ream or enlarge a hole 230 in a wall 200. However, for larger holes 230 and installations lacking fins 32, the stopper 1 can be pushed straight into the wall without turning the stopper 1.

Once installed, caulking or silicone can be used to fill any gap between the door knob stopper 1 and the wall 200 for esthetic purposes and to aid in the creation of a smooth and paintable surface around the door knob stopper 1.

The various embodiments of door knob stoppers 1 of the present invention can be installed into a wide variety of walls 200. In general, all of the embodiments described herein can be installed in drywall. They will also work in plaster walls. However, plaster walls with lathe interior structures may require that a hole be cut into the lathe to receive the door knob stopper 1 receptacle 5.

The door knob stoppers 1 of the present invention can be installed to prevent initial damage from a door knob or they can be used to repair to damage or a hole 230 in the wall 200 caused by a door knob and, as such, to prevent additional future damage. The door knob stoppers 1 of the present invention offer a strong, quick, and affordable solution compared to other door knob stoppers 1 on the market.

What is claimed is:

1. A door knob stopper configured to receive a door knob into a hole in a wall, the door knob stopper comprising:
a receptacle sized to receive a door knob, wherein the receptacle has a circumferential sidewall having an interior and an exterior, the circumferential sidewall connecting a rear wall to a face plate having a front side and a back side; and
a securing mechanism to secure the door knob stopper to the hole in the wall.

2. The door knob stopper of claim 1, wherein the securing mechanism is comprised of a plurality of fins along the exterior of the circumferential sidewall to exert pressure between the door knob stopper and the hole.

3. The door knob stopper of claim 1, wherein the securing mechanism is comprised of a plurality of teeth located on the back side of the face plate to secure the door knob stopper to the wall.

4. The door knob stopper of claim 1, further comprising a spacer attached to the back side of the face plate and configured to create space between the back side of the face plate and the wall.

5. The door knob stopper of claim 1, wherein the receptacle and the face plate are a one-piece structure.

6. The door knob stopper of claim 2, wherein the fins are metal.

7. The door knob stopper of claim 3, wherein the teeth are metal.

8. A method of installing a door knob stopper into a wall having a hole, the door knob stopper having a receptacle with a rear wall configured to receive a door knob, a circumferential sidewall with an exterior, and a securing mechanism, and the method comprising:
aligning the rear wall of the receptacle with the hole in the wall; and
pushing and turning the door knob stopper until the securing mechanism cuts into and grabs the wall around the hole.

9. The method of claim 8, further comprising continuing to push the door knob stopper into the wall until it is flush with the wall.

10. The method of claim 8, further comprising, as an initial step, the creation of the hole in the wall.

11. The method of claim 8, wherein the securing mechanism is a plurality of fins located along the exterior of the circumferential sidewall .

12. A method of installing a door knob stopper into a wall having a hole, the door knob stopper having a receptacle with a rear wall configured to receive a door knob and a securing mechanism, and the method comprising:
aligning the rear wall of the receptacle with the hole in the wall; and
pushing the door knob stopper until the securing mechanism cuts into and grabs the wall around the hole.

13. The method of claim 12, further comprising, as an initial step, the creation of the hole in the wall.

14. The method of claim 13, wherein the securing mechanism is teeth.
